(19) United States
(12) Patent Application Publication
(10) Pub. No.: US 2005/0259702 A1
(43) Pub. Date: Nov. 24, 2005

(54) Optical head device

(76) Inventors: Hiroshi Kubota, Nagano (JP); Yasuyuki Tsukioka, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/123,824

(22) Filed: May 6, 2005

(30) Foreign Application Priority Data
May 7, 2004 (JP) 2004-138479
May 19, 2004 (JP) 2004-149125

(51) Int. Cl. H01S 3/04

(52) U.S. Cl. 372/34

(57) ABSTRACT

An optical head device includes a heat-radiating body for radiating heat generated in the laser beam emitting element which is disposed so as to have a gap space with respect to the laser beam emitting element and a heat-conductive member which is filled in the gap space between the laser beam emitting element and the heat-radiating body. The heat-conductive member is a gel-like heat-conductive member having a heat transmission property or a heat-conductive member having a heat transmission property and elasticity. Another optical head device includes an optical system including a laser driver for driving the laser beam emitting element, a frame on which the optical system is mounted, a cover which is fixed to the frame for protecting at least a part of the optical system and a heat-radiating body which is formed in a separated manner from the cover for radiating heat generated in the laser driver.

### CROSS-REFERENCE TO RELATED APPLICATIONS

This application claims priority to Japanese Application No. 2004-138479 filed May 7, 2004, Japanese Application No. 2004-149125 filed May 19, 2004, which are incorporated herein by reference.

### FIELD OF THE INVENTION

The present invention relates to an optical head device that is used to record or reproduce information on or from an optical disk such as a CD or a DVD. More specifically, the present invention relates to a heat radiating structure for a laser beam emitting element and to a heat radiating structure for a laser driver for driving the laser beam emitting element which are provided in the optical head device.

### BACKGROUND OF THE INVENTION

An optical head device which is used to record and reproduce information on and from an optical disk such as a CD and a DVD includes a laser beam emitting element as a light source, an objective lens for converging a laser beam emitted from the laser beam emitting element on the optical disk, a light receiving element for receiving a return light beam from the optical disk, a frame on which an optical system having the laser beam emitting element is mounted, and the like.

In this type of optical head device, a high output laser beam emitting element is used as the laser beam emitting element for performing recording on the optical disk. Since the heat-generating amount of the high output laser beam emitting element is large, it is necessary to effectively diffuse heat generation occurred in the laser beam emitting element. Therefore, a holder which holds the laser beam emitting element is conventionally fixed to a frame with an adhesive through a heat-conductive plate that is brought into surface contact with the frame to effectively diffuse heat generation occurred in the laser beam emitting element (for example, see Japanese Patent Laid-Open No. 2004-14007).

Further, another optical head device includes an optical system having a laser beam emitting element as a light source, a laser driver for driving the laser beam emitting element, a frame on which the optical system is mounted, a cover which is fixed to the frame for protecting the optical system, and the like.

In the optical head device, the cover for protecting the optical system is commonly formed of a metal plate that is made of stainless steel. Heat generation occurred in the laser driver is radiated by the cover. In other words, the cover which is also served as a heat sink for the laser driver is used in the conventional optical head device. The construction of the conventional optical head device is concretely described with reference to FIGS. 11 through 13.

As shown in FIG. 11, the conventional optical head device 101 includes a laser beam emitting element 102 as a light source, a laser driver 104 that is mounted on a circuit board 103 for driving the laser beam emitting element 102, and a frame 105 on which an optical system (the details are omitted in the drawing) having the laser beam emitting element 102 is mounted and fixed. A cover 106 made of a stainless-steel plate is fixed to the frame 105 with a fixing screw 108 for protecting the optical system as shown in FIG. 12.

The cover 106 is fixed so as to cover a major portion on the bottom side of the frame 105 as shown in FIG. 12 and optical elements constructing the optical system is covered by the cover 106. Further, the cover 106 is brought into contact with the laser driver 104 through a heat-conductive sheet 107 having a heat transmission property and elasticity as shown in FIG. 13. Therefore, the heat generation occurred in the laser driver 104 is diffused or radiated to the frame 105 through the heat-conductive sheet 107 and thus the cover 106 provides a function as a heat sink for the laser driver 104.

In the optical head device disclosed in Japanese Patent Laid-Open No. 2004-14007, the holder which holds the laser beam emitting element is brought into contact with the frame through the plate having a heat transmission property. Therefore, the heat generation occurred in the laser beam emitting element can be effectively radiated by utilizing the frame. However, the holder is required to be adhesively fixed under the state where the holder is made contact with the plate that is brought into surface contact with the frame. Therefore, the fixing position of the laser beam emitting element in the optical axis direction cannot be adjusted. Accordingly, other optical components have to be adjusted after the laser beam emitting element has been fixed to the frame and thus time and labor are imposed on the adjustment of the optical system. Further, since other optical components cannot be adjusted unless after the laser beam emitting element has been fixed to the frame, the degree of freedom for adjusting processes of the optical system decreases.

In order to eliminate the problem described above, it is conceivable that an adhesive having a heat transmission property is used to fix a laser beam emitting element to the frame so that the fixing position of the laser beam emitting element in the optical axis direction can be adjusted while a heat dissipation property is ensured. However, the used amount of the adhesive is limited in consideration of the workability in adhesion process and thus the heat generation occurred in the laser beam emitting element cannot be sufficiently radiated by using the adhesive.

Alternatively, when the above-mentioned conventional optical head device 101 is used, the temperature of the cover 106 rises as the temperature of the laser driver 104 has risen because the cover 106 has a function as a heat sink for the laser driver 104. Since the cover 106 covers the major portion on the bottom face side of the frame 105 on which the optical system is mounted, the temperature of the entire frame 105 also rises as the temperature of the cover 106 has risen. Further, the temperature of the optical elements that are disposed to be covered by the cover 106 rises as the temperature of the cover 106 has risen.

As the recording density and the recording speed for an optical disk in recent years become higher, the heat-generating amount occurred in the laser driver for driving the laser beam emitting element has increased. Since the heat-generating amount occurred in the laser driver increases, the temperature of the entire frame 105 rises higher and the temperature of the optical elements disposed to be covered by the cover 106 rises higher. As a result, the optical characteristics of the optical head device 101 may be affected. In other words, the deviation occurs at the fixing position of the optical elements constructing the optical system due to the rising of the temperature in the frame 105, and thus the optical characteristics of the optical head device 101 are affected.

### SUMMARY OF THE INVENTION

In view of the problems described above, it is an object and advantage of the present invention to provide an optical head device in which the fixing position of a laser beam emitting element to a frame is capable of being adjusted in the optical axis direction of a laser beam and the heat generated in the laser beam emitting element is capable of being effectively radiated or diffused.

Further, in view of the problems described above, it is another object and advantage of the present invention to provide an optical head device in which positional deviation of optical elements due to heat generated in a laser driver can be prevented and effect on optical characteristics due to heat generated in the laser driver can be restrained.

In order to achieve the above object and advantage, according to an embodiment of the present invention, there is provided an optical head device including a laser beam emitting element as a light source, an objective lens for converging a laser beam emitted from the laser beam emitting element on an optical disk, a light receiving element for receiving a return light beam from the optical disk, a frame to which at least the laser beam emitting element is adhesively fixed in the state that fixing position of the laser beam emitting element to the frame is capable of being adjusted in an optical axis direction of the laser beam, a heat-radiating body for radiating heat generated in the laser beam emitting element which is disposed so as to have a gap space with respect to the laser beam emitting element, and a heat-conductive member which is filled in the gap space between the laser beam emitting element and the heat-radiating body. The heat-conductive member is a gel-like heat-conductive member having a heat transmission property or a heat-conductive member having a heat transmission property and elasticity.

In accordance with an embodiment of the present invention, the optical head device further includes a holder for holding the laser beam emitting element which is adhesively fixed to the frame such that a gap space is present between the holder and the frame.

In accordance with an embodiment of the present invention, since a holder for holding the laser beam emitting element is adhesively fixed to the frame such that a gap space is present between the holder and the frame, the fixing position to the frame of the laser beam emitting element can be adjusted in the optical axis direction of a laser beam. Further, the heat-radiating body for radiating heat generated in the laser beam emitting element and the laser beam emitting element are disposed so as to have a gap space between them and a gel-like heat-conductive member having a heat transmission property or a heat-conductive member having a heat transmission property and elasticity is filled in the gap space between the laser beam emitting element and the heat-radiating body. Therefore, the heat generated in the laser beam emitting element can be effectively diffused by the heat-radiating body through the heat-conductive member. Further, the effect of the stress caused by the heat-radiating body on the laser beam emitting element becomes small enough to ignore. In other words, a gel-like member or a member having elasticity is used as the heat-conductive member. Therefore, even when deformation or the like occurs in the heat-radiating body due to change in temperature or the like, the stress of the heat-radiating body caused by the deformation or the like is absorbed by the heat-conductive member, and thus the laser beam emitting element is hardly subjected to the effect of the stress. Accordingly, even when the laser beam emitting element is adhesively fixed to the frame without interposing a rigid body such as a holder or a plate as in the conventional example, the deviation of the mounting position of the laser beam emitting element does not occur due to the stress caused by the heat-radiating body. Therefore, even when a construction exists such that the fixing position to the frame of the laser beam emitting element may be adjusted in the optical axis direction of the laser beam, the laser beam emitting element can be stably fixed to the frame.

In accordance with an embodiment of the present invention, a holder which holds the laser beam emitting element may be adhesively bonded to the frame such that a prescribed gap space is present between the holder and the frame, or the laser beam emitting element may be adhesively bonded to the frame such that a prescribed clearance is present between the laser beam emitting element and the frame.

In accordance with an embodiment of the present invention, the heat-conductive member is heat conductive grease. The heat conductive grease is a general-purpose product and thus can be easily obtained at a low cost. Therefore, the product cost of the optical head device can be reduced. Since the heat conductive grease is a gel-like grease, the heat conductive grease which is the heat-conductive member can be filled in the gap space between the laser beam emitting element and the heat-radiating body even after the laser beam emitting element has been adhesively fixed to the frame and the heat-radiating body is fixed to the frame.

In accordance with an embodiment of the present invention, the laser beam emitting element is provided with a terminal extended on an opposite side to the emitting direction of the laser beam and the heat-radiating body is a heat radiation plate that is disposed on the terminal side of the laser beam emitting element. Alternatively, the frame itself to which the laser beam emitting element is adhesively fixed in the light-emitting direction of the laser beam may be used as the heat-radiating body.

In accordance with an embodiment of the present invention, the heat radiation plate is provided with a heat radiation part for radiating heat generated in the laser beam emitting element provided on the optical disk side. In this case, convection is generated by the rotation of the optical disk and thus the heat of the heat radiation plate is effectively radiated.

In accordance with an embodiment of the present invention, the heat radiation plate is provided with an aperture part that is formed in an extending direction of the terminal. In this case, a short circuit between the terminal and the heat radiation plate can be prevented. Further, the heat-conductive member can be filled in the gap space between the laser beam emitting element and the heat radiation plate from the aperture part and thus the filling operation of the heat-conductive member becomes easy.

In accordance with an embodiment of the present invention, the heat-conductive member has an electromagnetic wave absorption characteristic. In this case, the noise generated from the laser beam emitting element can be absorbed by the heat-conductive member, and thus erroneous operations of the optical head device which may occur by the noise of the laser beam emitting element can be prevented.

Also, in order to achieve the above-mentioned another object and advantage, according to an embodiment of the present invention, there is provided an optical head device including an optical system having a laser beam emitting element as a light source, a laser driver for driving the laser beam emitting element, a frame on which the optical system is mounted, a cover which is fixed to the frame for protecting at least a part of the optical system, and a heat-radiating body which is formed in a separated manner from the cover for radiating heat generated in the laser driver.

In accordance with the embodiment of the present invention, the heat-radiating body for radiating heat generated in the laser driver is formed in a separated manner from the cover that is fixed to the frame for protecting at least a part of the optical system. Therefore, the heat generated in the laser driver is radiated by the heat-radiating body that is formed in a separated manner from the cover. Accordingly, temperature rising of the entire frame and temperature rising of optical elements disposed to be covered with the cover can be restrained even when the cover is formed so as to cover the major portion on the bottom face side of the frame for appropriately protecting the optical system.

In accordance with an embodiment of the present invention, the cover is a metal plate made of stainless steel and the heat-radiating body is a metal plate made of copper or aluminum. In this case, the optical system is adequately protected by the stainless steel plate with a high degree of rigidity and the heat generated in the laser driver can be effectively radiated by the copper plate or the aluminum plate with a high degree of heat radiation property.

In accordance with an embodiment of the present invention, the heat-radiating body includes a heat absorption part for absorbing heat generated in the laser driver and a heat radiation part for radiating heat absorbed by the heat absorption part, and at least a part of the heat radiation part is disposed on the optical disk side. In this case, convection is generated by the rotation of the optical disk and thus the heat absorbed by the heat absorption part can be effectively radiated from the heat radiation part.

In accordance with an embodiment of the present invention, the heat-radiating body includes a heat absorption part for absorbing heat generated in the laser driver, a heat radiation part for radiating heat absorbed by the heat absorption part, and a fixing part for being fixed to the frame, and only the fixing part of the heat-radiating body is brought into contact with the frame. In this case, the increased temperature of the entire frame can be restrained because the heat-radiating body does not contact with the frame except the fixing part.

In accordance with an embodiment of the present invention, the heat-radiating body includes a heat absorption part for absorbing heat generated in the laser driver, a heat radiation part for radiating heat absorbed by the heat absorption part, and a fixing part for being fixed to the frame, and the heat radiation part is disposed between the heat absorption part and the fixing part. The heat-radiating body is constructed so as to be brought into contact with the frame at the fixing part which is fixed to the frame, and the heat of the heat-radiating body is transmitted to the frame through the fixing part. In accordance with the embodiment of the present invention, since the heat radiation part is disposed between the heat absorption part and the fixing part, the heat absorbed by the heat absorption part is radiated from the heat radiation part and thus the heat quantity transmitted to the fixing part is lessened. As a result, the heat quantity transmitted to the frame can be reduced.

In accordance with an embodiment of the present invention, the heat-radiating body is a heat radiation plate which is formed by bending a metal plate, and the heat-radiating plate is formed such that the heat absorption part is disposed on one end side of the heat radiation plate and the fixing part is disposed on the other side of the heat radiation plate in a developed state of the heat radiation plate. Since the heat-radiating plate is formed such that the heat absorption part is disposed on one end side and the fixing part is disposed on the other side in its developed state, the heat absorption part and the fixing part are disposed in a separated manner and thus the heat quantity which is absorbed by the heat absorption part and transmitted to the fixing part is lessened. As a result, the heat quantity transmitted to the frame from the heat radiation plate can be restrained at the fixing part where the heat radiation plate is in contact with the frame.

As described above, in the optical head device in accordance with the present invention, the fixing position to the frame of the laser beam emitting element is capable of being adjusted in the optical axis direction of the laser beam. Therefore, the laser beam emitting element can be adjusted and then fixed to the frame even after other optical components have been fixed to the frame. Accordingly, adjustment steps for the optical system can be shortened and the degree of freedom is given to the adjustment steps for the optical system.

Further, the heat-radiating body for radiating heat generated in the laser beam emitting element and the laser beam emitting element are disposed so as to have a gap space between them and a gel-like heat-conductive conductive member having a heat transmission property or a heat-conductive member having a heat transmission property and elasticity is filled in the gap space between the laser beam emitting element and the heat-radiating body. Therefore, the heat generated in the laser beam emitting element can be effectively released by the heat-radiating body through the heat-conductive member. Further, the effect of the stress caused by the heat-radiating body to the laser beam emitting element becomes smaller enough to ignore because the heat-conductive member absorbs the stress caused by the heat-radiating body. Therefore, the laser beam emitting element can be stably fixed to the frame even when it is constructed such that the fixing position to the frame of the laser beam emitting element is capable of being adjusted in the optical axis direction of a laser beam. As a result, according to the optical head device in the present invention, the fixing position to the frame of the laser beam emitting element is capable of being adjusted in the optical axis direction of the laser beam and the heat generated in the laser beam emitting element can be effectively released.

In addition, in the optical head device in accordance with another present invention, the heat-radiating body for releasing heat generated in the laser driver is formed in a separated manner from the cover that is fixed to the frame for protecting at least a part of the optical system. Therefore, the heat generated in the laser driver is released by the heat-radiating body that is formed in a separated manner from the cover. Accordingly, temperature rising of the entire frame and temperature rising of optical elements disposed to be covered with the cover can be restrained even when the cover is formed so as to cover the major portion on the bottom face side of the frame for appropriately protecting the optical system. As a result, the positional deviation of the optical elements due to heat generated in the laser driver can be prevented and the effect on the optical characteristics due to heat generated in the laser driver can be restrained.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a perspective view showing the entire construction of an optical head device in accordance with a first embodiment of the present invention.

FIG. 2 is a schematic construction view showing the construction of an optical system of the optical head device shown in FIG. 1.

FIG. 3 is a bottom view showing the bottom face of the optical head device shown in FIG. 1, in which a cover is detached.

FIG. 4 is an enlarged bottom view which shows an enlarged fixing part of a first laser beam emitting element viewed from the bottom face side.

FIG. 5 is an enlarged side view which shows an enlarged fixing part of the first laser beam emitting element viewed from A-A direction shown in FIG. 3.

FIG. 6 is a perspective view showing the entire construction of an optical head device in accordance with a modified example of the first embodiment of the present invention.

FIG. 7 is a perspective view showing an optical head device in accordance with a second embodiment of the present invention viewed from the tracking direction.

FIG. 8 is a perspective view showing the optical head device shown in FIG. 7 that is viewed from the jitter direction.

FIG. 9 is a side view showing the side face in the tracking direction of the optical head device shown in FIG. 7.

FIG. 10 is a bottom view showing the bottom face of the optical head device shown in FIG. 7.

FIG. 11 is a bottom view showing the bottom face of a conventional optical head device in which a cover is detached.

FIG. 12 is a bottom view showing the bottom face of the conventional optical head device.

FIG. 13 is a partial side view showing the heat radiating structure of a laser driver in the conventional optical head device.

### DETAILED DESCRIPTION OF THE PREFERRED EMBODIMENTS

Embodiments of the present invention will be described below with reference to the accompanying drawings.

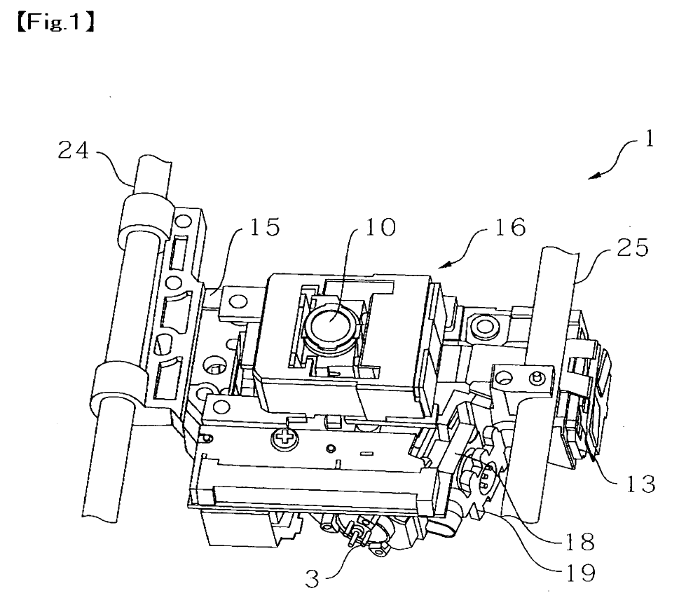

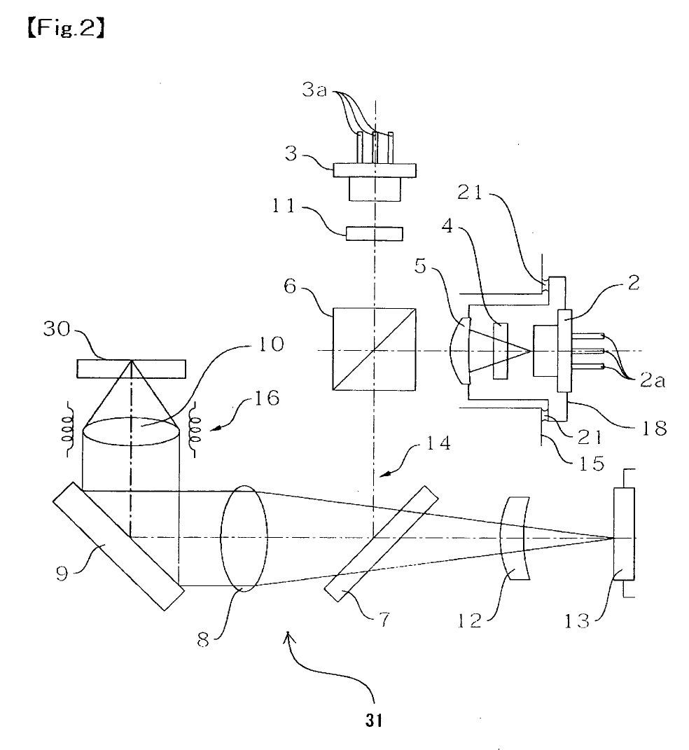

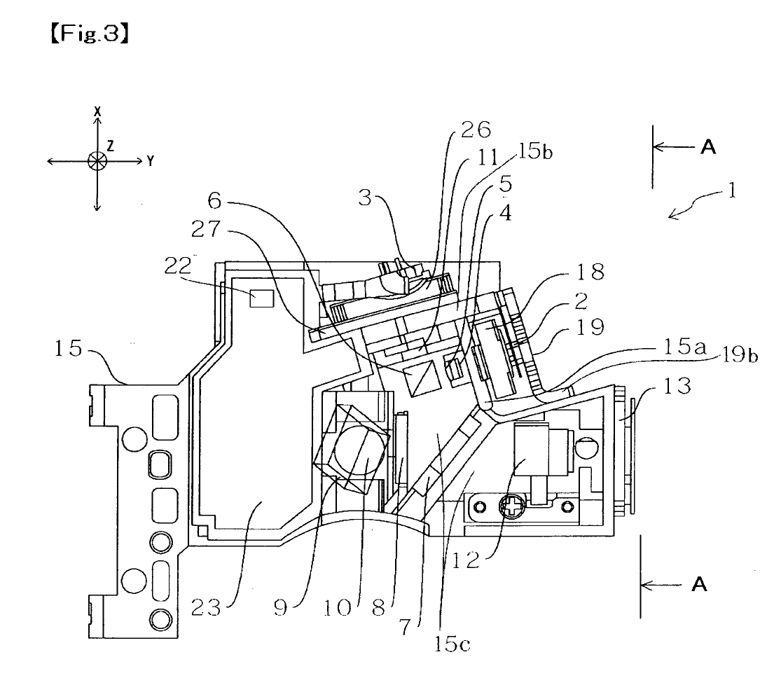

FIG. 1 is a perspective view showing the entire construction of an optical head device in accordance with a first embodiment of the present invention. FIG. 2 is a schematic construction view showing the construction of the optical system of the optical head device shown in FIG. 1. FIG. 3 is a bottom view showing the bottom face of the optical head device shown in FIG. 1. In FIG. 3, the bottom face of the optical head device is shown for convenience of description in which a bottom cover that is the component part of the optical head device is detached.

An optical head device 1 in accordance with a first embodiment of the present invention performs information recording and reproducing on and from an optical disk 30 such as a CD or a DVD. The optical head device 1 is provided with a frame 15 on which an optical system 31 and the like are mounted. The frame 15 is slidably mounted along two guide shafts 24, 25 which are disposed in a mutually parallel manner with respect to the main body of an optical disk recording and reproducing apparatus (not shown in the drawing). In the embodiments of the present invention, the radial direction of the optical disk 30 (tracking direction) is defined as an “X” direction, the tangential direction of the optical disk 30 (jitter direction) is defined as a “Y” direction, and the orthogonal direction of the optical disk 30 (focusing direction) is defined as a “Z” direction.

The optical system 31 in the optical head device 1 is provided as a light source with a first laser beam emitting element 2 for emitting a long wavelength laser beam (first laser beam) with a wavelength of 780 nm to 800 nm for a CD and a second laser beam emitting element 3 for emitting a short wavelength laser beam (second laser beam) with a wavelength of 630 nm or 650 nm for a DVD. The first laser beam emitting element 2 is provided with three terminals 2a which are extended in an opposite direction to the light-emitting direction of the laser beam. Similarly, the second laser beam emitting element 3 is provided with three terminals 3a which are extended in an opposite direction to the light-emitting direction of the laser beam.

In the optical system 31 in accordance with the first embodiment of the present invention, the first laser beam and the second laser beam are guided to a common optical path 14 for directing to the optical disk 30 by a prism 6 that is an optical element for optical path synthesis. In the common optical path 14 are disposed a half mirror 7 for reflecting parts of the first laser beam and the second laser beam to the optical disk 30, a collimator lens 8 for making the reflected light from the half mirror 7 in a parallel light, a raising mirror 9 for bending the emitted light beam from the collimator lens 8 to the optical disk 30, and an objective lens 10 for converging the laser beam which is converted in a parallel light with the collimator lens 8 on the optical disk 30 in this order.

On the optical path from the first laser beam emitting element 2 to the prism 6 where the first laser beam emitted from the first laser beam emitting element 2 is guided to the common optical path 14 are disposed a grating 4 for dividing the first laser beam into three beams and a relay lens 5 for changing the divergence angle of the laser beams divided into three beams in this order. The first laser beam which is made incident on the prism 6 through the grating 4 and the relay lens 5 is partly reflected by the prism 6 and guided to the common optical path 14.

Further, on the optical path from the second laser beam emitting element 3 to the prism 6 where the second laser beam emitted from the second laser beam emitting element 3 is guided to the common optical path 14 is disposed a grating 11 for dividing the second laser beam into three beams. The second laser beam which is made incident on the prism 6 through the grating 11 is partly transmitted through the prism 6 and guided to the common optical path 14.

A sensor lens 12 and a light receiving element 13 are disposed on the side of the half mirror 7. The return light beam which is reflected by the optical disk 30 is made incident on the half mirror 7 through the objective lens 10, the raising mirror 9 and the collimator lens 8. A part of the incident light transmits the half mirror 7 to be guided to the sensor lens 12 and the light receiving element 13. In other words, in the embodiment of the present invention, the half mirror 7 is an element for optical path separation.

The relay lens 5 has a positive power with which a laser beam whose divergence angle is smaller than that of the first laser beam that is made incident through the grating 4 is emitted to the prism 6. The relay lens 5, the grating 4 and the first laser beam emitting element 2 are integrated together as described later.

The sensor lens 12 generates astigmatism in the return light beam from the optical disk 30 and increases the magnifying power of the return light beam (magnifying power of the spot on the light receiving element 13 with respect to the spot on the optical disk 30) from about 8 times to about 17 times, and compensates coma aberration occurred in the half mirror 7. A large circular spot is formed on the light receiving element 13 by the sensor lens 12 and a focusing servo signal and a tracking servo signal with a good quality can be obtained.

In the embodiment of the present invention, the magnifying power of the emitted light beam (magnifying power of the light emitting point of the first laser beam emitting element 2 with respect to the spot on the optical disk 30) is about 4 times and the numerical aperture (NA) of the objective lens 10 is about 0.5 in the optical system of the first laser beam emitted from the first laser beam emitting element 2 when the effect of the relay lens 5 is not considered. On the other hand, the magnifying power of the emitted light beam (magnifying power of the light emitting point of the second laser beam emitting element 3 with respect to the spot on the optical disk 30) is about 5.5 times to 7 times and the numerical aperture (NA) of the objective lens 10 is about 0.6 to 0.68 in the optical system of the second laser beam emitted from the second laser beam emitting element 3. Further, the magnifying power of the emitted light beam from the first laser beam emitting element 2 is approximately the same as that of the emitted light beam of the second laser beam emitting element 3 when the effect of the relay lens 5 is considered. The common optical path 14 can be utilized in the optical system of both the first laser beam emitting element 2 and the second laser beam emitting element 3 by using the relay lens 5.

The frame 15 in the embodiment of the present invention is, for example, made of aluminum molded by die-casting. The frame 15 is provided with a recessed part 15c on which a part of the optical system 31 is mounted on the bottom face side (see FIG. 3). On the recessed part 15c are fixed some parts of the optical elements constructing the optical system 31 such as the prism 6, the half mirror 7, the collimating lens 8 and the raising mirror 9. Further, on the side face of the frame 15 are formed a fixing part 15a for fixing the first laser beam emitting element 2 and a fixing part 15b for fixing the second laser beam emitting element 3. The fixing part 15a and the fixing part 15b are formed to be perpendicular to each other.

The optical head device 1 is provided with an objective lens drive device 16 for driving the objective lens 10 in a focusing direction and a tracking direction. The objective lens drive device 16 is mounted on an upper face side of the frame 15. The objective lens drive device 16 includes a tracking drive coil, a tracking driving magnet, a focusing drive coil, a focusing driving magnet and the like. Their construction is well known and thus their detailed description is omitted. Further, in the optical head device 1, a circuit board 23 provided with drive circuits and the like for driving the first laser beam emitting element 2 and the second laser beam emitting element 3 is mounted on the rear face side of the frame 15.

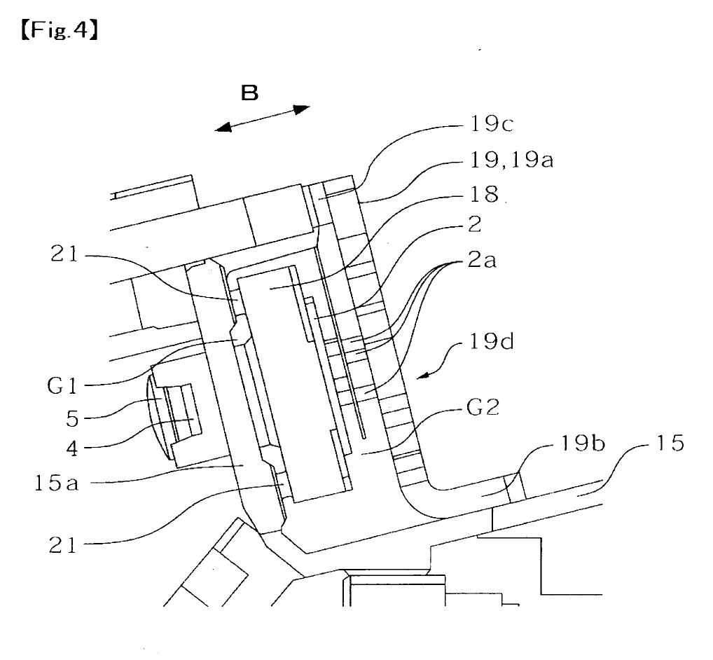

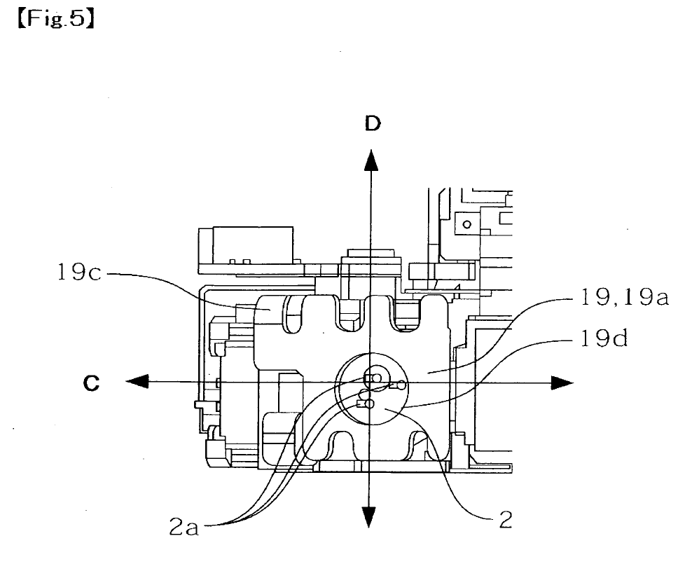

FIG. 4 is an enlarged bottom view which shows the enlarged fixing part of the first laser beam emitting element viewed from the bottom face side. FIG. 5 is an enlarged side view which shows the enlarged fixing part of the first laser beam emitting element viewed from the A-A direction shown in FIG. 3.

The optical head device 1 in the embodiment of the present invention is provided with a holder 18 that holds the first laser beam emitting element 2. The first laser beam emitting element 2, the grating 4 and the relay lens 5 are fixed on the holder 18, and thus a laser emitting unit is constructed in which at least the first laser beam emitting element 2 and the relay lens 5 are integrated with each other.

The holder 18 constructing the laser emitting unit is adhesively fixed to the fixing part 15a of the frame 15 with an adhesive 21. In other words, the first laser beam emitting element 2 is adhesively fixed to the frame 15 through the holder 18. More concretely, the holder 18 is fixed to the fixing part 15a through a gap space G1 as shown in FIG. 4. Since the gap space G1 is formed between the holder 18 and the fixing part 15a, the fixing position of the holder 18 can be adjusted in a “B” direction that is the optical axis direction of the first laser beam. The fixing position of the holder 18 can be also adjusted in a “C” direction and a “D” direction which are the directions perpendicular to the optical axis of the first laser beam (see FIG. 5).

Further, the second laser beam emitting element 3, which is held on the holder 26, is adhesively fixed on the fixing part 15b of the frame 15 through a planar plate 27 having a heat transmission property which is brought into surface contact with the frame 15. In other words, the holder 26 which holds the second laser beam emitting element 3 is adhesively fixed to the frame 15 through the planar plate 27 having a heat transmission property that is brought into surface contact with the frame 15 (see FIG. 3).

A heat radiation plate 19 is disposed on the terminal 2a side of the first laser beam emitting element 2 as a heat-radiating body for radiating heat generated in the first laser beam emitting element 2. More concretely, the first laser beam emitting element 2 and the heat radiation plate 19 are disposed with a gap space G2 therebetween. Further, a gel-like heat-conductive member having a heat transmission property or a heat-conductive member having a heat transmission property and elasticity is filled in the gap space G2 between the first laser beam emitting element 2 and the heat radiation plate 19. Specifically, silicon grease that is heat conductive grease is filled in the gap space G2.

The heat radiation plate 19 in the embodiment of the present invention is formed by bending a metal flat plate with a high degree of heat transmission property such as copper or aluminum. The heat radiation plate 19 is formed of a base part 19a which is parallel to the C-D plane, a mounting part 19b which is bent from the base part 19a so as to be parallel to the B-D plane, and a mounting part 19c which is bent from the base part 19a so as to be parallel in the B-C plane in a fixing state to the optical head device 1. The mounting part 19b and the mounting part 19c are adhesively fixed to the frame 15 under the state that they are brought into surface contact with the frame 15 and thus the heat in the heat radiation plate 19 can be radiated to the frame 15. An aperture part 19d is formed in the base part 19a of the heat radiation plate 19 in an extending direction of the terminals 2a of the first laser beam emitting element 2. Therefore, the base part 19a and the terminals 2a do not contact with each other under the, state that the first laser beam emitting element 2 and the heat radiation plate 19 are mounted on the frame 15.

The heat-conductive member in the embodiment of the present invention is a gel-like heat-conductive member and is specifically, heat conductive grease. More specifically, the heat-conductive member is silicon grease.

In the optical head device 1 constructed as described above, the first laser beam emitting element 2 is fixed to the frame 15 as the following steps.

First, the first laser beam emitting element 2 is fixed to the holder 18 together with the grating 4 and the relay lens 5 to construct a laser emitting unit. After a part of the holder 18 is inserted into a fitting hole of the frame 15 and the holder 18 is adhesively bonded with an adhesive 21 to the fixing part 15a under the state that the holder 18 has been adjusted in three dimensions of the B-direction, C-direction and D-direction. In this way, the laser emitting unit is fixed to the frame 15. In this situation, a gap space G1 is formed between the holder 18 and the fixing part 15a.

Then, the heat radiation plate 19 whose fixing position has been adjusted in the B direction is adhesively fixed to the frame 15 at the positions of the mounting parts 19b and 19c. More specifically, the heat radiation plate 19 is adhesively fixed so as to provide the gap space G2 with the first laser beam emitting element 2 so that the terminals 2a are not short circuited with the heat radiation plate 19. In this state, the silicon grease which is heat conductive grease is filled into the gap space G2 from the aperture part 19d. In the state where the heat radiation plate 19 is adhesively fixed to the frame 15, a part of the terminal 2a is disposed in the aperture part 19d. Therefore, relative distance between the first laser beam emitting element 2 and the heat radiation plate 19 can be shortened. Accordingly, the heat generated in the first laser beam emitting element 2 can be effectively dissipated by the heat radiation plate 19 through the silicon grease and further the downsizing of the optical head device 1 can be attained in the “B” direction.

As described above, in the optical head device 1 in accordance with the first embodiment of the present invention, the holder 18 holding the first laser beam emitting element 2 is fixed to the frame 15 with an adhesive through the prescribed gap space G1 and thus the fixing position of the first laser beam emitting element 2 to the frame 15 is adjustable in the 37 B” direction. Therefore, the first laser beam emitting element 2 can be adjusted and then fixed to the frame 15 even after other optical components have been fixed to the frame 15. Accordingly, adjustment steps for the optical system can be shortened and the degree of freedom can be attained in the adjustment steps.

Further, in the first embodiment of the present invention, the heat radiation plate 19 for radiating heat generated in the first laser beam emitting element 2 and the first laser beam emitting element 2 are disposed through the gap space G2. In addition, silicon grease which is a gel-like heat-conductive member having a heat transmission property is filled into the gap space G2 between the first laser beam emitting element 2 and the heat radiation plate 19. Therefore, heat generated in the first laser beam emitting element 2 can be effectively dissipated with the heat radiation plate 19 through the silicon grease. Further, the effect on the first laser beam emitting element 2 due to the stress caused by the heat radiation plate 19 becomes small enough to ignore. In other words, since gel-like silicon grease is employed as the heat-conductive member, the first laser beam emitting element 2 hardly receive the effects due to the stress even when the heat radiation plate 19 may be deformed due to temperature changes. Therefore, even when the holder 18 is adhesively fixed to the frame 15 through the gap space G1, the fixing position of the first laser beam emitting element 2 is not displaced due to the stress caused by the heat radiation plate 19. Accordingly, although the fixing position of the first laser beam emitting element 2 to the frame 15 is constructed so as to be adjustable in the optical axis direction of the first laser beam (“B” direction), the first laser beam emitting element 2 can be stably fixed to the frame 15.

In the first embodiment of the present invention, silicon grease that is the heat conductive grease is used as the heat-conductive member. Silicon grease can be obtained easily as a general-purpose product at low cost. Therefore, the product cost of the optical head device 1 can be reduced by using silicon grease. Further, since silicon grease is a gel-like grease, the silicon grease which is the heat-conductive member can be filled in the gap space G2 between the first laser beam emitting element 2 and the heat radiation plate 19 even after the holder 18 has been adhesively fixed to the frame 15 and then the heat radiation plate 19 is adhesively fixed to the frame 15.

In the embodiment of the present invention, the aperture part 19d is formed in the heat radiation plate 19 in the extending direction of the terminals 2a. Therefore, the short circuit between the terminals 2a and the heat radiation plate 19 can be securely prevented. Further, silicon grease which is the heat-conductive member can be filled in the gap space G2 between the first laser beam emitting element 2 and the heat radiation plate 19 from the aperture part 19d and thus the filling operation of the heat-conductive member becomes easy.

Further, in the embodiment of the present invention, the magnifying power of the emitted light beam is about 4 times in the optical system of the first laser beam emitted from the first laser beam emitting element 2 when the effect of the relay lens 5 is not considered and the magnifying power is set to be smaller. Therefore, for example, when recording is performed on a CD-R, a spot whose power is large can be formed on the optical disk 30. Further, more light can be utilized with a little emitted light by increasing the optical transmission efficiency. On the other hand, the magnifying power of the optical system with respect to the second laser beam emitted from the second laser beam emitting element 3 is about 5.5 times to 7 times and the magnifying power is set to be larger. Therefore, for example, when reproduction from a DVD is performed, a small spot can be formed on the optical disk 30.

In addition, in the embodiment of the present invention, the first laser beam emitting element 2 and the relay lens 5 are integrated with the holder 18 to form a laser emitting unit. The laser emitting unit is fixed to the frame 15 on which the optical system is mounted. Therefore, the laser emitting unit provided with the first laser beam emitting element 2 and the relay lens 5 can be regarded as a single light source, and thus the magnifying power of the optical system with respect to the emitted beam from the laser emitting unit can be regarded as the magnifying power including the magnifying power of the relay lens 5, i.e., the magnifying power in which the effect of the relay lens 5 is considered. Accordingly, the difference between the magnifying power of the optical system to the emitted light beam from the laser emitting unit and the magnifying power to the return light beam can be reduced and thus the effect of the deviation of the optical axis position of the spot on the light receiving element 10 due to the mounting error of the laser emitting unit can be reduced.

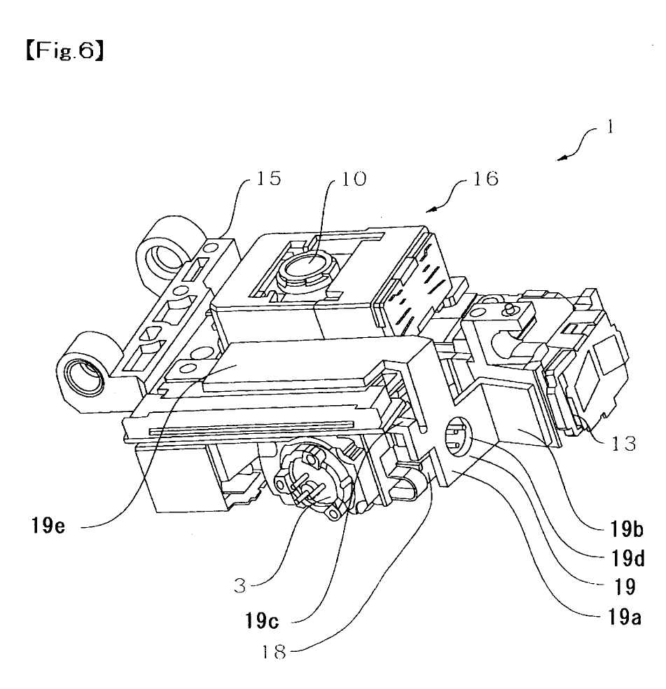

The present invention is not limited to the first embodiment described above and many modifications can be made without departing from the subject matter of the present invention. For example, the optical head device 1 shown in FIG. 6 is a modified example of the first embodiment which is provided with the heat radiation plate 19 in which a heat radiation part 19e is further formed on the upper face side of the frame 15, i.e., on the optical disk 30 side for radiating the heat generated in the first laser beam emitting element 2. The heat radiation plate 19 in this modified embodiment will be specifically described below.

The heat radiation plate 19 is constructed such that the base part 19a is extended to the upper face side of the frame 15 (“D” direction) and the heat radiation part 19e is extended from the end part of the base part 19a in the “D” direction so as to be parallel in the B-C plane in comparison with the heat radiation plate 19 in the first embodiment. The heat radiation part 19e is provided with a large surface area as shown in FIG. 6 so as to have approximately the same length as that of the objective lens drive device 16 in the “B” direction. Therefore, heat generated in the first laser beam emitting element 2 can be further effectively radiated. In addition, since the heat radiation plate 19 is provided with the heat radiation part 19e on the optical disk 30 side, convection is generated by the rotation of the optical disk 30 and thus the heat in the heat radiation plate 19 can be effectively radiated. The heat radiation plate 19 in this modified embodiment is similar to the above-mentioned heat radiation plate 19 except that the heat radiation part 19e is added.

In the embodiments described above, the silicon grease that is heat conductive grease is used as a heat-conductive member, but the heat-conductive member is not limited to silicon grease. For example, heat conductive grease other than silicon grease, paste-like heat conductive gel, sheet-shaped heat conductive grease, sheet-shaped heat conductive gel or heat conductive silicone rubber sheet can be used as the heat-conductive member. In other words, when a gel-like and heat-conductive member having a heat transmission property or a heat-conductive member having a heat transmission property and elasticity is used as the heat-conductive member, the above-mentioned effective heat radiation effects can be obtained and the fixing position of the first laser beam emitting element 2 can be prevented from being displaced due to the stress caused by the heat radiation plate 19. Therefore, the first laser beam emitting element 2 can be stably fixed to the frame 15 even when the fixing position of the first laser beam emitting element 2 to the frame 15 is constructed so as to be adjusted in the optical axis direction of the first laser beam.

In addition, a heat-conductive member having electromagnetic wave absorption characteristics such as a paste-like heat conductive gel having a high-frequency electromagnetic wave absorption property may be used as the heat-conductive member. In this case, the occurrence of noise from the first laser beam emitting element 2 is restricted and thus a suitable control for the optical head device 1 can be attained.

Furthermore, in the embodiment described above, silicon grease is filled between the first laser beam emitting element 2 and the heat radiation plate 19 but silicon grease may be filled in the gap space G1 between the holder 18 and the frame 15. In this case, the peeling of the adhesive 21 due to the effect of silicon grease is required to be considered. However, the heat generated in the first laser beam emitting element 2 can be effectively radiated to the frame 15 when this construction is employed.

Further, in the embodiment described above, the first laser beam emitting element 2 is adhesively fixed to the frame 15 through the holder 18. However, a prescribed gap space may be provided between the first laser beam emitting element 2 and the frame 15, and the first laser beam emitting element 2 may be adhesively fixed to the frame 15 directly with an adhesive 21.

In addition, the holder 26 for the second laser beam emitting element 3 and the frame 15 may be adhesively fixed together through a prescribed gap space in the same way as in the first laser beam emitting element 2, and a heat radiation plate may be provided to radiate the heat generated in the second laser beam emitting element 3.

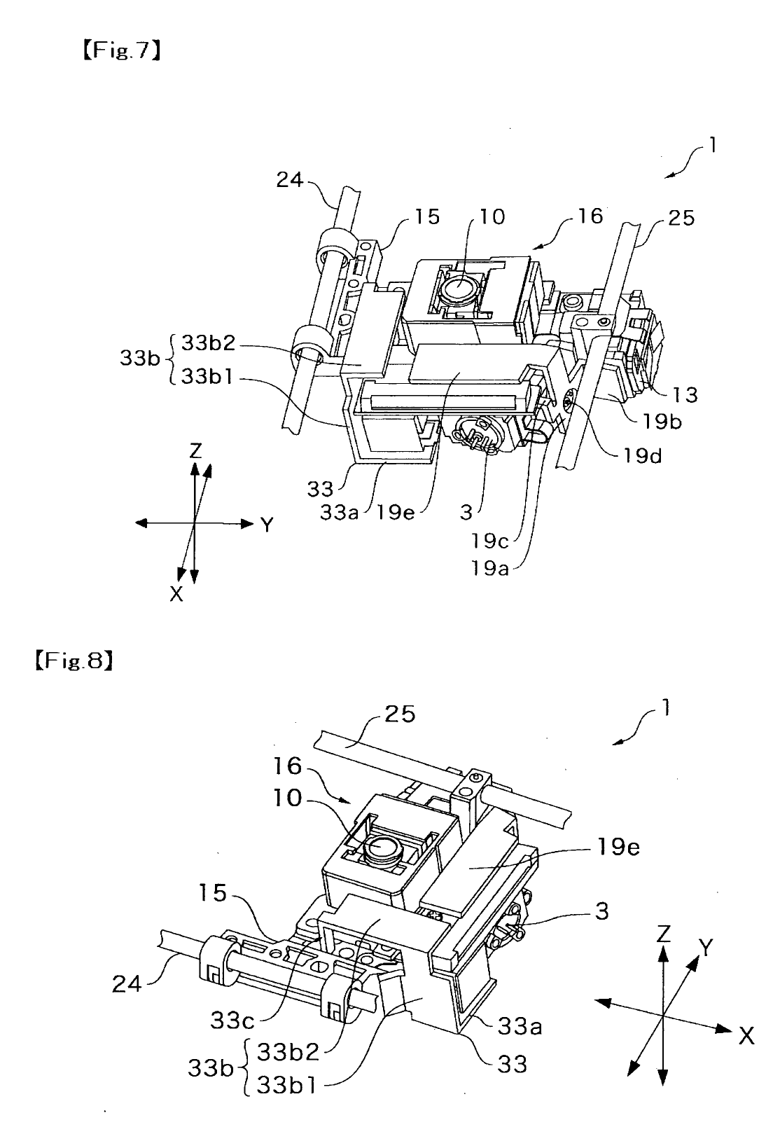

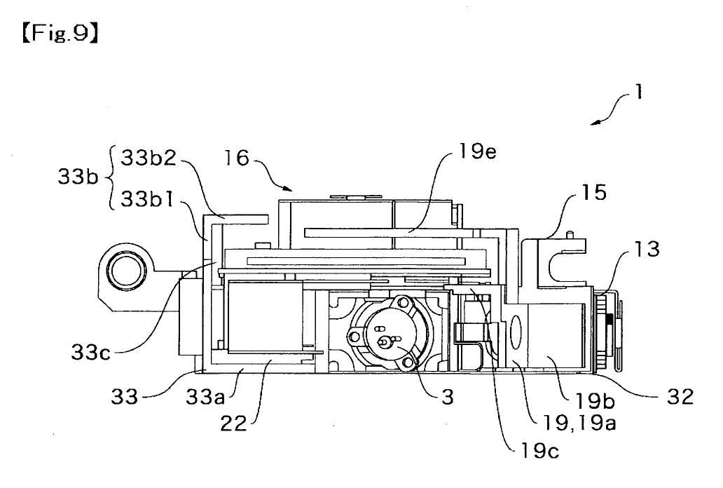

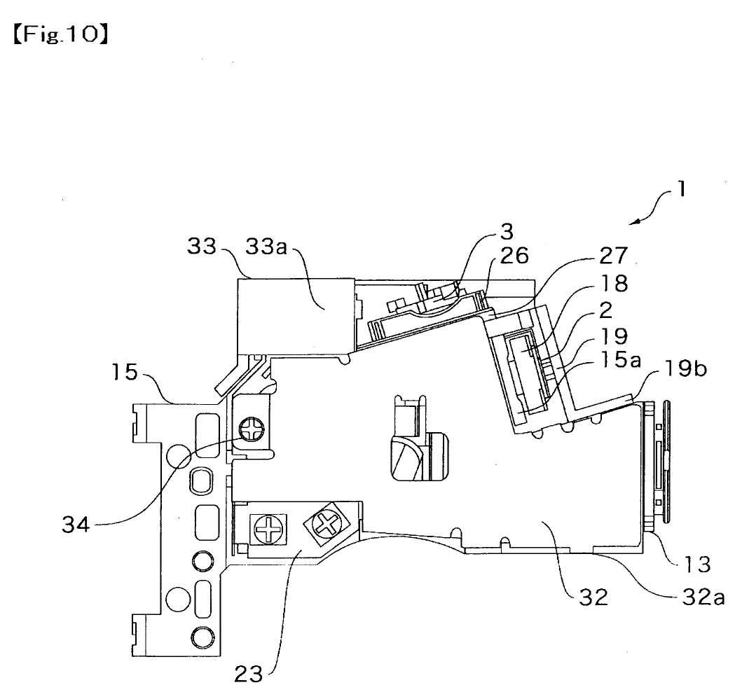

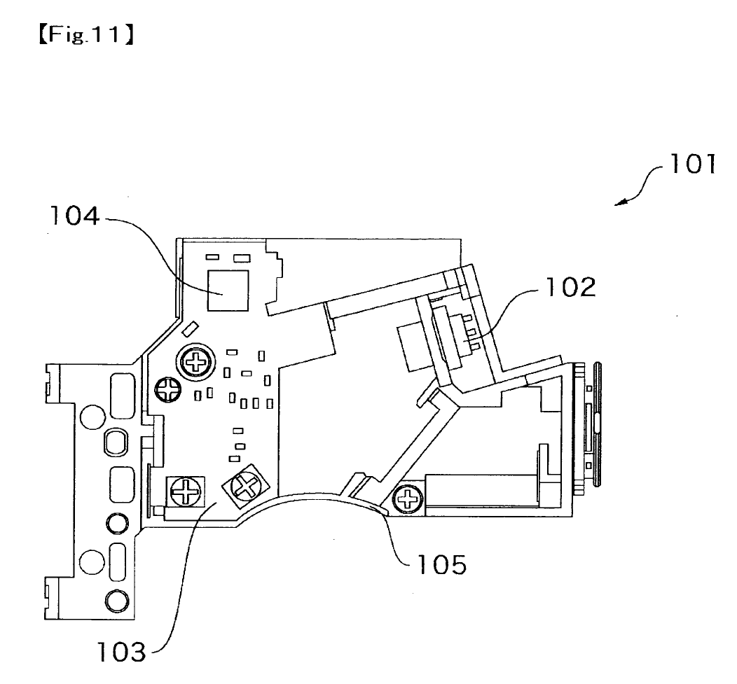

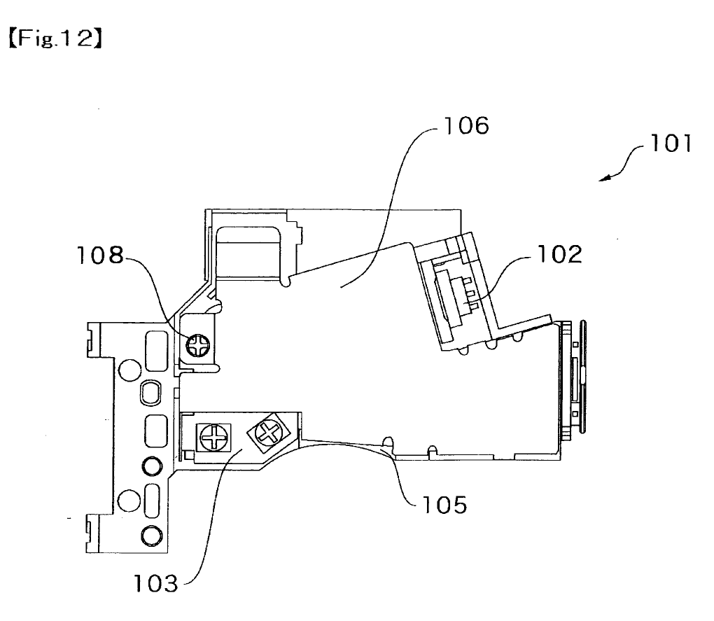

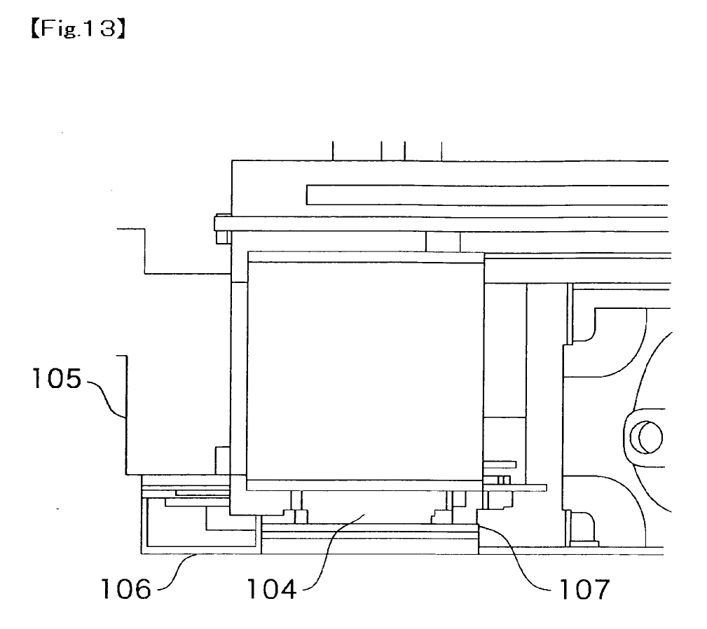

Next, an optical head device in accordance with a second embodiment of the present invention, which is capable of restraining the problem of heat generated in a laser driver, will be described with reference to the accompanying drawings. FIG. 7 is a perspective view showing an optical head device in accordance with the second embodiment of the present invention viewed from the tracking direction. FIG. 8 is a perspective view showing the optical head device shown in FIG. 7 that is viewed from the jitter direction. FIG. 9 is a side view showing the side face in the tracking direction of the optical head device shown in FIG. 7. FIG. 10 is a bottom view showing the bottom face of the optical head device shown in FIG. 7. The same structural elements as those of the optical head device described in the above-mentioned embodiments are shown with the same notational symbol and their detailed description is omitted.

A circuit board 23 is mounted on the bottom face of the frame 15 on which a laser driver 22 is placed for driving the first laser beam emitting element 2 and the second laser beam emitting element 3 (see FIG. 3).

A cover 32 is fixed on the bottom face side of the frame 15 for protecting optical elements such as the prism 6 that is fixed on the recessed part 15c (see FIG. 10). The cover 32 is made of a stainless-steel plate and formed in a flat plate shape. A fixing part 32a is extended in the Z-direction to be fixed to the frame 15. The cover 32 is fixed to the frame 15 by a fixing screw 34 and the fixing part 32a to cover the entire recessed part 15c and part of the circuit board 23.

In the optical head device 1 in accordance with the second embodiment, the heat generated in the laser driver 22 is diffused by a heat radiation plate 33 as a heat-radiating body. The heat radiation plate 33 is constructed in a separate manner from the cover 32 and fixed so as to come into contact with the surface of the laser driver 22 under the state that the heat radiation plate 33 does not contact with the cover 32 (see FIGS. 9 and 10).

The heat radiation plate 33 in this embodiment of the present invention is formed by bending a metal plate made of copper or aluminum. The heat radiation plate 33 is provided with a heat absorption part 33a for absorbing heat generated in the laser driver 22, a heat radiation part 33b for radiating the heat absorbed by the heat absorption part 33a, and a fixing part 33c that is fixed to the frame 15 (see FIG. 8). The heat absorption part 33a, the heat radiation part 33b and the fixing part 33c are adjacently formed in this order. In other words, the heat radiation part 33b is disposed between the heat absorption part 33a and the fixing part 33c.

More specifically, in the state that the heat radiation plate 33 is fixed to the frame 15, the heat absorption part 33a is formed parallel to the X-Y plane so as to contact with the surface of the laser driver 22. As shown in FIG. 8, the heat radiation part 33b includes a first heat radiation part 33b1, which is extended in the Z-direction from a Y-direction end part of the heat absorption part 33a so as to be formed parallel to the X-Z plane, and a second heat radiation part 33b2 which is extended in the X-direction from a Z-direction end part (upper end in the drawing) of the first heat radiation part 33b1 so as to be formed parallel to the X-Y plane. The fixing part 33c is extended toward the heat absorption part 33a in the Z-direction from an X-direction end part of the second heat radiation part 33b2 in the extending direction from the first heat radiation part 33b1 so as to be formed parallel to the Y-Z plane. Therefore, in the planar state in which the heat radiation plate 33 is developed, the heat absorption part 33a is disposed on one end side and the fixing part 33c is disposed on the other end side. Further, the fixing part 33c is formed narrower in comparison with the heat absorption part 33a and the heat radiation part 33b.

The heat radiation plate 33 is fixed so that the tip end part of the fixing part 33c (lower end part in the drawing) is adhesively bonded to the frame 15 and the heat absorption part 33a is bonded to the laser driver 22. In the state that the heat radiation plate 33 is fixed to the frame 15, the second heat radiation part 33b2 which is a part of the heat radiation part 33b is disposed on the upper face side of the frame 15, in other words, on the optical disk 30 side. Further, in the state that the heat radiation plate 33 is fixed to the frame 15, only the tip end part of the fixing part 33c is constructed so as to contact with the frame 15, and a prescribed gap space is provided between a portion except the tip end part of the fixing part 33c and the frame 15, and between the heat radiation part 33b and the frame 15.

As described above, in the optical head device 1 in the second embodiment of the present invention, the heat radiation plate 33 for radiating heat generated in the laser driver 22 is constructed in a separated manner from the cover 32 and fixed in the state where the heat radiation plate 33 does not contact with the cover 32. Therefore, temperature rising of the entire frame 15 and temperature rising of optical elements disposed to be covered with the cover 32 can be restrained even when the cover 32 is formed so as to cover the entire recessed part 15c of the frame 15 for appropriately protecting a part of the optical system 31. As a result, the positional deviation of the optical elements due to heat generated in the laser driver 22 can be prevented and the effect to the optical characteristics due to heat generated in the laser driver 22 can be restrained.

Further, since the temperature rising of the frame 15 due to the laser driver 22 can be restrained, the heat generated in the first laser beam emitting element 2 or the second laser beam emitting element 3 can be released to the frame 15 through the heat radiation plate 19 or the plate 27. As a result, the temperature of the first laser beam emitting element 2 and the second laser beam emitting element 3 can be lowered. The heat-generating amount of the first laser beam emitting element 2 and the second laser beam emitting element 3 is little in comparison with the heat-generating amount of the laser driver 22. Therefore, the effect on the optical elements can be almost ignored even when the heat generated in the first laser beam emitting element 2 and the second laser beam emitting element 3 is released to the frame 15.

In the embodiment of the present invention, the cover 32 is made of a stainless-steel plate and the heat radiation plate 33 is a metal plate made of copper or aluminum. Therefore, a part of the optical system 31 is appropriately protected by the stainless-steel plate with a high degree of rigidity and the heat generated in the laser driver 22 can be effectively radiated by a copper plate or an aluminum plate which has a higher heat radiation property than the stainless-steel plate.

In the embodiment of the present invention, the heat radiation plate 33 is provided with the heat absorption part 33a for absorbing the heat generated in the laser driver 22, the heat radiation part 33b for radiating the heat absorbed by the heat absorption part 33a, and the fixing part 33c that is fixed to the frame 15. In addition, the second heat radiation part 33b2 constructing a part of the heat radiation part 33b is disposed on the optical disk 30 side. Therefore, convection is generated by the rotation of the optical disk 30 and thus the heat absorbed by the heat absorption part 33a can be effectively diffused by the heat radiation part 33b, particularly, in the second heat radiation part 33b2.

Further, in the embodiment of the present invention, only the fixing part 33c, which is formed narrower in comparison with the heat absorption part 33a and the heat radiation part 33b, is brought into contact with the frame 15. More concretely, only the tip end part of the fixing part 33c is in contact with the frame 15. Therefore, the contact area of the heat radiation plate 33 with the frame 15 can be made smaller. Accordingly, temperature rising of the frame 15 can be restrained even when a part of the heat radiation plate 33 is fixed to the frame 15 to stabilize the position of the heat radiation plate 33.

In addition, in the embodiment of the present invention, the heat radiation part 33b is disposed between the heat absorption part 33a and the fixing part 33c. The heat radiation plate 33 is brought into contact with the frame 15 at the position of the fixing part 33c which is fixed to the frame 15 and the heat of the heat radiation plate 33 is transmitted to the frame 15. In the embodiment of the present invention, since the heat radiation part 33b is disposed between the heat absorption part 33a and the fixing part 33c, the heat absorbed by the heat absorption part 33a is radiated by the heat radiation part 33b and thus the transmission amount of heat to the fixing part 33c can be reduced. As a result, heat amount transmitted to the frame 15 can be reduced.

Especially, in the embodiment of the present invention, the heat absorption part 33a is disposed on the one end side and the fixing part 33c is disposed on the other side when the heat radiation plate 33 is developed. In other words, the heat absorption part 33a and the fixing part 33c of the heat radiation plate 33 are disposed in the most separated positions with each other. Therefore, the transmission amount to the fixing part 33c of the heat absorbed by the heat absorption part 33a is lessened. As a result, even at the fixing part 33c where the heat radiation plate 33 and the frame 15 are brought into contact with each other, the heat amount transmitted from the heat radiation plate 33 to the frame 15 can be restrained.

The present invention is not limited to the second embodiment described above and many modifications can be made without departing from the subject matter of the present invention. For example, it may be constructed such that a part of the heat radiation part 33b of the heat radiation plate 33 is brought into contact with the guide shaft 24. Thereby, heat radiation effect by the heat radiation part 33b can be increased. Further, the heat radiation plate 33 may not be provided with the heat radiation part 33b and may be formed with only the heat absorption part 33a. On the other hand, the heat radiation plate 33 may be constructed of only the heat absorption part 33a and the first heat radiation part 33b1.

In addition, in the second embodiment described above, the heat radiation plate 33 is adhesively fixed to the laser driver 22 directly. However, the heat radiation plate 33 may be fixed to the laser driver 22 through a heat-conductive sheet having a heat transmission property.

In addition, in the embodiment described above, a thin plate-shaped heat radiation plate 33 is used as a heat-radiating body. However, the heat-radiating body is not necessary to be formed of a thin plate-shaped heat radiation plate. For example, the heat-radiating body may be formed in a block shape.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An optical head device comprising:
a laser beam emitting element as a light source;
an objective lens for converging a laser beam emitted from the laser beam emitting element on an optical disk;
a light receiving element for receiving a return light beam from the optical disk;
a frame to which at least the laser beam emitting element is adhesively fixed in a state wherein fixing position of the laser beam emitting element to the frame is capable of being adjusted in an optical axis direction of the laser beam;
a heat-radiating body for radiating heat generated in the laser beam emitting element which is disposed so as to have a gap space with respect to the laser beam emitting element; and
a heat-conductive member which is filled in the gap space between the laser beam emitting element and the heat-radiating body;
wherein the heat-conductive member is one of a gel-like heat-conductive member having a heat transmission property and a heat-conductive member having a heat transmission property and elasticity.

2. The optical head device according to claim 1, further comprising a holder for holding the laser beam emitting element which is adhesively fixed to the frame such that a gap space is present between the holder and frame.

3. The optical head device according to claim 1, wherein the heat-conductive member is a heat conductive grease.

4. The optical head device according to claim 1, wherein the laser beam emitting element is provided with a terminal extended on an opposite side to an emitting direction of the laser beam and the heat-radiating body is a heat radiation plate disposed on a terminal side of the laser beam emitting element.

5. The optical head device according to claim 4, wherein the heat radiation plate is provided with a heat radiation part on the optical disk side for radiating heat generated in the laser beam emitting element.

6. The optical head device according to claim 4, wherein the heat radiation plate is provided with an aperture part formed in an extending direction of the terminal.

7. The optical head device according to claim 1, wherein the heat-conductive member is provided with an electromagnetic wave absorption characteristic.

8. An optical head device comprising:
an optical system including a laser beam emitting element as a light source;
a laser driver for driving the laser beam emitting element;
a frame on which the optical system is mounted;
a cover which is fixed to the frame for protecting at least a part of the optical system; and
a heat-radiating body which is formed in a separated manner from the cover for radiating heat generated in the laser driver.

9. The optical head device according to claim 8, wherein the cover is a metal plate made of stainless steel and the heat-radiating body is a metal plate made of copper or aluminum.

10. The optical head device according to claim 8, wherein the heat-radiating body includes a heat absorption part for absorbing heat generated in the laser driver and a heat radiation part for radiating heat absorbed by the heat absorption part, and at least a part of the heat radiation part is disposed on the optical disk side.

11. The optical head device according to claim 8, wherein the heat-radiating body includes a heat absorption part for absorbing heat generated in the laser driver, a heat radiation part for radiating heat absorbed by the heat absorption part, and a fixing part for being fixed to the frame, and only the fixing part of the heat-radiating body is brought into contact with the frame.

12. The optical head device according to claim 8, wherein the heat-radiating body includes a heat absorption part for absorbing heat generated in the laser driver, a heat radiation part for radiating heat absorbed by the heat absorption part, and a fixing part for being fixed to the frame, and the heat radiation part is disposed between the heat absorption part and the fixing part.

13. The optical head device according to claim 11, wherein the heat-radiating body is a heat radiation plate which is formed by bending a metal plate, and the heat absorption part is disposed on one end side of the heat radiation plate and the fixing part is disposed on the other side of the heat radiation plate in a developed state of the heat radiation plate.

14. The optical head device according to claim 12, wherein the heat-radiating body is a heat radiation plate which is formed by bending a metal plate, and the heat absorption part is disposed on one end side of the heat radiation plate and the fixing part is disposed on the other side of the heat radiation plate in a developed state of the heat radiation plate.
